(19) United States
(12) Patent Application Publication
(10) Pub. No.: US 2021/0207540 A1
(43) Pub. Date: Jul. 8, 2021

(54) SYSTEMS AND METHODS FOR FUEL CELL AUXILIARY POWER IN SECONDARY FUEL APPLICATIONS

(71) Applicant: UNITED TECHNOLOGIES CORPORATION, Farmington, CT (US)

(72) Inventor: Gary D. Roberge, Tolland, CT (US)

(73) Assignee: UNITED TECHNOLOGIES CORPORATION, Farmington, CT (US)

(21) Appl. No.: 16/732,774

(22) Filed: Jan. 2, 2020

(51) Int. Cl. F02C 7/224; B64D 41/00; B64D 37/30; B64D 37/08; B64D 31/14; F02C 7/232; F02C 9/28

(52) U.S. Cl. CPC F02C 7/224; B64D 41/00; B64D 37/30; B64D 2041/005; B64D 31/14; F02C 7/232; F02C 9/28; B64D 37/08

(57) ABSTRACT

A cryogenic fuel auxiliary power system for an engine may include a cryogenic fuel supply, a first valve in fluid communication with the cryogenic fuel supply and configured to control a fuel flow, a first heat exchanger, configured to receive the fuel flow, in fluid communication with the first valve and a combustion chamber of the engine, and a fuel cell in fluid communication between the first valve and the first heat exchanger.

### FIELD

The present disclosure relates generally to aircraft systems and, more particularly, to aircraft power plant and auxiliary systems.

### BACKGROUND

It has been proposed to operate gas turbine engines, such as those used to propel aircraft, by using more than one type of fuel. Such fuels may be used together simultaneously or selectively during differing periods of operation. In such regimes, it is usual to use a conventional fuel such as, for example, kerosene as the primary fuel and a secondary fuel such as a cryogenic liquid fuel. The cryogenic fuel may be burned to power the engine either simultaneously with the primary fuel or as a substitute during certain periods of engine operation. Operating engines with blended traditional and cryogenic fuels may tend to enhance engine performance.

### SUMMARY

In various embodiments, a cryogenic fuel auxiliary power system for an engine comprises a cryogenic fuel supply, a first valve in fluid communication with the cryogenic fuel supply and configured to control a fuel flow, a first heat exchanger, configured to receive the fuel flow, in fluid communication with the first valve and a combustion chamber of the engine, and a fuel cell in fluid communication between the first valve and the first heat exchanger.

In various embodiments, a second valve may be in fluid communication with the fuel cell and the first heat exchanger and configured to interrupt the fluid communication therebetween. In various embodiments, a byproduct line may be in fluid communication with the fuel cell and a byproduct storage tank, wherein the fuel cell is configured to supply byproduct to the byproduct storage tank in response to receiving the fuel flow. In various embodiments, a transfer pump may be in fluid communication between the fuel cell and the byproduct storage tank. In various embodiments, a third valve may be in fluid communication between the byproduct storage tank and the engine, wherein the third valve is configured to supply the byproduct to a mass injection system of the engine. In various embodiments, a second pump may be in fluid communication between the third valve and the engine, wherein the second pump is configured to boost the pressure of the byproduct above an operating pressure of the engine. In various embodiments, a fourth valve may be in fluid communication between the byproduct storage tank and a drain. In various embodiments, a second heat exchanger may be in fluid communication between the first valve and the fuel cell.

In various embodiments, the system further comprises a controller a sensor in communication with the controller and configured to provide sensor feedback and a tangible, non-transitory memory configured to communicate with the controller, the tangible, non-transitory memory having instructions stored thereon that, in response to execution by the controller, cause the controller to perform operations comprising determining a ground power condition, controlling the first valve and the second valve in response to the ground power condition, and controlling the fuel cell in response to the ground power condition.

In various embodiments, the operations further comprise determining a first operating condition of the engine, configuring the second valve to enable fluid communication between the fuel cell and the first heat exchanger in response to the first operating condition, and configuring the first valve to supply a first portion of the fuel flow to the fuel cell and a second portion of the fuel flow to the first heat exchanger in response to the first operating condition.

In various embodiments, the operations further comprise determining a second operating condition of the engine, configuring the second valve to inhibit fluid communication between the fuel cell and the first heat exchanger in response to the second operating condition, and configuring the first valve to supply the fuel flow to the first heat exchanger in response to the second operating condition. In various embodiments, the operations further comprise determining a mass injection condition and controlling a third valve to enable fluid communication between the byproduct tank and the engine in response to the mass injection condition. In various embodiments, the operation further comprise receiving a fluid level signal from a fluid level sensor in electronic communication with the controller and controlling a fourth valve in response to the fluid level signal.

In various embodiments, a method of controlling a cryogenic fuel auxiliary power system for an engine comprises determining a ground power condition, controlling the first valve and the second valve in response to the ground power condition, and controlling the fuel cell in response to the ground power condition.

In various embodiments, method includes determining a first operating condition of the engine, configuring the second valve to enable fluid communication between the fuel cell and the first heat exchanger in response to the first operating condition, and configuring the first valve to supply a first portion of the fuel flow to the fuel cell and a second portion of the fuel flow to the first heat exchanger in response to the first operating condition.

In various embodiments, method includes determining a second operating condition of the engine, configuring the second valve to inhibit fluid communication between the fuel cell and the first heat exchanger in response to the second operating condition, and configuring the first valve to supply the fuel flow to the first heat exchanger in response to the second operating condition. In various embodiments, method includes determining a mass injection condition and controlling a third valve to enable fluid communication between the byproduct tank and the engine in response to the mass injection condition. In various embodiments, method includes receiving a fluid level signal from a fluid level sensor in electronic communication with the controller and controlling a fourth valve in response to the fluid level signal.

In various embodiments, an article of manufacture is provided. The article of manufacture may include a tangible, non-transitory computer-readable storage medium having instructions stored thereon that, in response to execution by a processor, cause the processor to perform operations comprising determining a ground power condition, controlling the first valve and the second valve in response to the ground power condition, and controlling the fuel cell in response to the ground power condition.

In various embodiments, the operations further comprise determining a first operating condition of the engine, configuring the second valve to enable fluid communication between the fuel cell and the first heat exchanger in response to the first operating condition, and configuring the first valve to supply a first portion of the fuel flow to the fuel cell and a second portion of the fuel flow to the first heat exchanger in response to the first operating condition.

In various embodiments, the operations further comprise determining a second operating condition of the engine, configuring the second valve to inhibit fluid communication between the fuel cell and the first heat exchanger in response to the second operating condition, and configuring the first valve to supply the fuel flow to the first heat exchanger in response to the second operating condition. In various embodiments, the operations further comprise determining a mass injection condition and controlling a third valve to enable fluid communication between the byproduct tank and the engine in response to the mass injection condition. In various embodiments, the operation further comprise receiving a fluid level signal from a fluid level sensor in electronic communication with the controller and controlling a fourth valve in response to the fluid level signal.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the figures, wherein like numerals denote like elements.

FIG. 1A illustrates an exemplary aircraft, in accordance with various embodiments;

FIG. 1B illustrates an exemplary gas turbine engine, in accordance with various embodiments;

FIG. 2 illustrates a cryogenic fuel auxiliary power system for an engine, in accordance with various embodiments; and

FIG. 3 illustrates a method of controlling a cryogenic fuel auxiliary power system for an engine, in accordance with various embodiments.

### DETAILED DESCRIPTION

All ranges and ratio limits disclosed herein may be combined. It is to be understood that unless specifically stated otherwise, references to “a,” “an,” and/or “the” may include one or more than one and that reference to an item in the singular may also include the item in the plural.

The detailed description of exemplary embodiments herein makes reference to the accompanying drawings, which show exemplary embodiments by way of illustration. While these exemplary embodiments are described in sufficient detail to enable those skilled in the art to practice the exemplary embodiments of the disclosure, it should be understood that other embodiments may be realized and that logical changes and adaptations in design and construction may be made in accordance with this disclosure and the teachings herein. Thus, the detailed description herein is presented for purposes of illustration only and not limitation.

The scope of the disclosure is defined by the appended claims and their legal equivalents rather than by merely the examples described. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, coupled, connected or the like may include permanent, removable, temporary, partial, full and/or any other possible attachment option. Additionally, any reference to without contact (or similar phrases) may also include reduced contact or minimal contact. Surface shading lines may be used throughout the figures to denote different parts but not necessarily to denote the same or different materials.

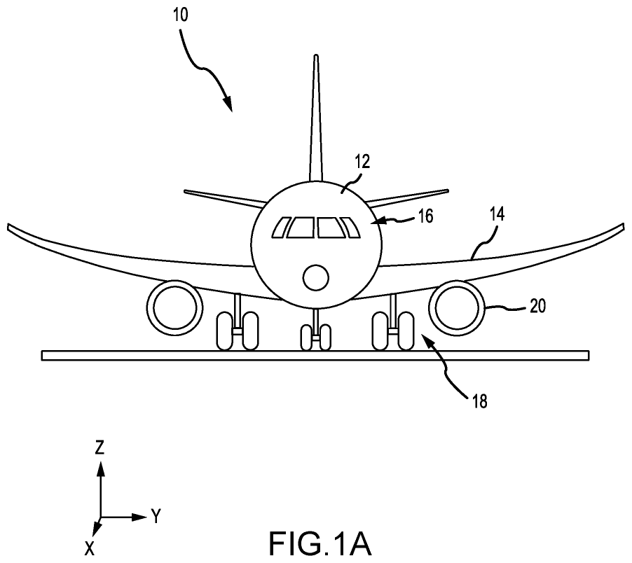

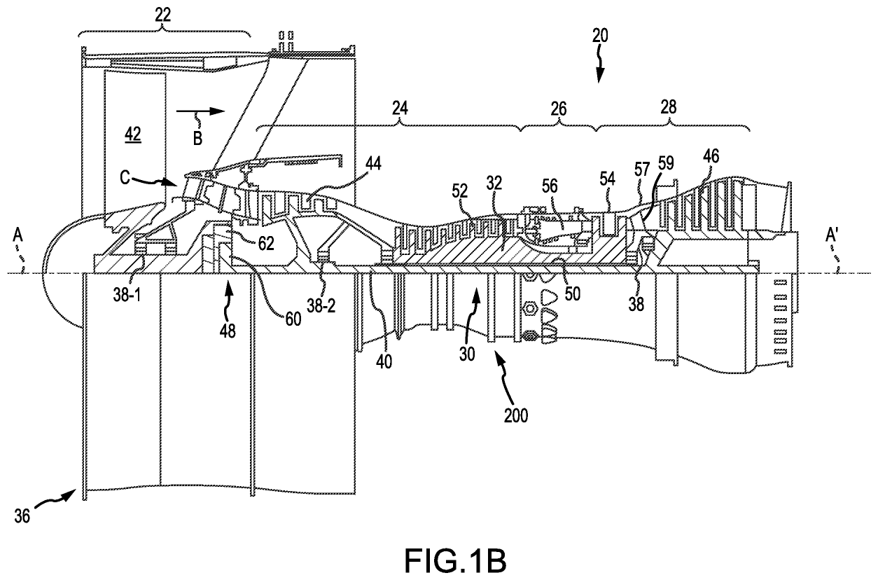

With reference to FIG. 1A, an aircraft 10 is illustrated in accordance with various embodiments. Aircraft 10 comprises a fuselage 12, wings 14, cockpit controls 16, landing gear 18, and a propulsion system, such as gas turbine engines 20. In various embodiments, aircraft 10 may include a cryogenic fuel auxiliary power system 200.

In various embodiments and with reference to FIG. 1B, a gas turbine engine 20 is provided. Gas turbine engine 20 may be a two-spool turbofan that generally incorporates a fan section 22, a compressor section 24, a combustor section 26 and a turbine section 28. In operation, fan section 22 can drive air along a bypass flow-path B while compressor section 24 can drive air through a core flow-path C for compression and communication into combustor section 26 then expansion through turbine section 28. In various embodiments, gas turbine engine 20 may incorporate a plurality of engine accessories such as, for example, components of power transfer system 200. Although depicted as a turbofan gas turbine engine 20 herein, it should be understood that the concepts described herein are not limited to use with turbofans as the teachings may be applied to other types of engines including turbojet engines, a low-bypass turbofans, a high bypass turbofans, reciprocating engines, or any other internal combustion engine known to those skilled in the art.

Gas turbine engine 20 may generally comprise a low speed spool 30 and a high speed spool 32 mounted for rotation about an engine central longitudinal axis A-A′ relative to an engine static structure 36 via one or more bearing systems 38 (shown as bearing system 38-1 and bearing system 38-2). It should be understood that various bearing systems 38 at various locations may alternatively or additionally be provided, including for example, bearing system 38, bearing system 38-1, and bearing system 38-2.

Low speed spool 30 may generally comprise an inner shaft 40 that interconnects a fan 42, a low pressure (or first) compressor section 44 (also referred to a low pressure compressor) and a low pressure (or first) turbine section 46. Inner shaft 40 may be connected to fan 42 through a geared architecture 48 that can drive fan 42 at a lower speed than low speed spool 30. Geared architecture 48 may comprise a gear assembly 60 enclosed within a gear housing 62. Gear assembly 60 couples inner shaft 40 to a rotating fan structure. High speed spool 32 may comprise an outer shaft 50 that interconnects a high pressure compressor (“HPC”) 52 (e.g., a second compressor section) and high pressure (or second) turbine section 54. A combustor 56 may be located between HPC 52 and high pressure turbine 54. A mid-turbine frame 57 of engine static structure 36 may be located generally between high pressure turbine 54 and low pressure turbine 46. Mid-turbine frame 57 may support one or more bearing systems 38 in turbine section 28. Inner shaft 40 and outer shaft 50 may be concentric and rotate via bearing systems 38 about the engine central longitudinal axis A-A′, which is collinear with their longitudinal axes. As used herein, a “high pressure” compressor or turbine experiences a higher pressure than a corresponding “low pressure” compressor or turbine.

The core airflow C may be compressed by low pressure compressor 44 then HPC 52, mixed and burned with fuel in combustor 56, then expanded over high pressure turbine 54 and low pressure turbine 46. Mid-turbine frame 57 includes airfoils 59 which are in the core airflow path. Low pressure turbine 46, and high pressure turbine 54 rotationally drive the respective low speed spool 30 and high speed spool 32 in response to the expansion.

Gas turbine engine 20 may be, for example, a high-bypass geared aircraft engine. In various embodiments, the bypass ratio of gas turbine engine 20 may be greater than about six (6). In various embodiments, the bypass ratio of gas turbine engine 20 may be greater than ten (10). In various embodiments, geared architecture 48 may be an epicyclic gear train, such as a star gear system (sun gear in meshing engagement with a plurality of star gears supported by a carrier and in meshing engagement with a ring gear) or other gear system. Geared architecture 48 may have a gear reduction ratio of greater than about 2.3 and low pressure turbine 46 may have a pressure ratio that is greater than about 5. In various embodiments, the bypass ratio of gas turbine engine 20 is greater than about ten (10:1). In various embodiments, the diameter of fan 42 may be significantly larger than that of the low pressure compressor 44, and the low pressure turbine 46 may have a pressure ratio that is greater than about (5:1). Low pressure turbine 46 pressure ratio may be measured prior to inlet of low pressure turbine 46 as related to the pressure at the outlet of low pressure turbine 46 prior to an exhaust nozzle. It should be understood, however, that the above parameters are exemplary of various embodiments of a suitable geared architecture engine and that the present disclosure contemplates other gas turbine engines including direct drive turbofans.

In various embodiments, the next generation of turbofan engines may be designed for higher efficiency which is associated with higher pressure ratios and higher temperatures in the HPC 52. These higher operating temperatures and pressure ratios may create operating environments that may cause thermal loads that are higher than the thermal loads encountered in conventional turbofan engines, which may shorten the operational life of current components.

In various embodiments, HPC 52 may comprise alternating rows of rotating rotors and stationary stators. Stators may have a cantilevered configuration or a shrouded configuration. More specifically, a stator may comprise a stator vane, a casing support and a hub support. In this regard, a stator vane may be supported along an outer diameter by a casing support and along an inner diameter by a hub support. In contrast, a cantilevered stator may comprise a stator vane that is only retained and/or supported at the casing (e.g., along an outer diameter).

In various embodiments, rotors may be configured to compress and spin a fluid flow. Stators may be configured to receive and straighten the fluid flow. In operation, the fluid flow discharged from the trailing edge of stators may be straightened (e.g., the flow may be directed in a substantially parallel path to the centerline of the engine and/or HPC) to increase and/or improve the efficiency of the engine and, more specifically, to achieve maximum and/or near maximum compression and efficiency when the straightened air is compressed and spun by rotor 64.

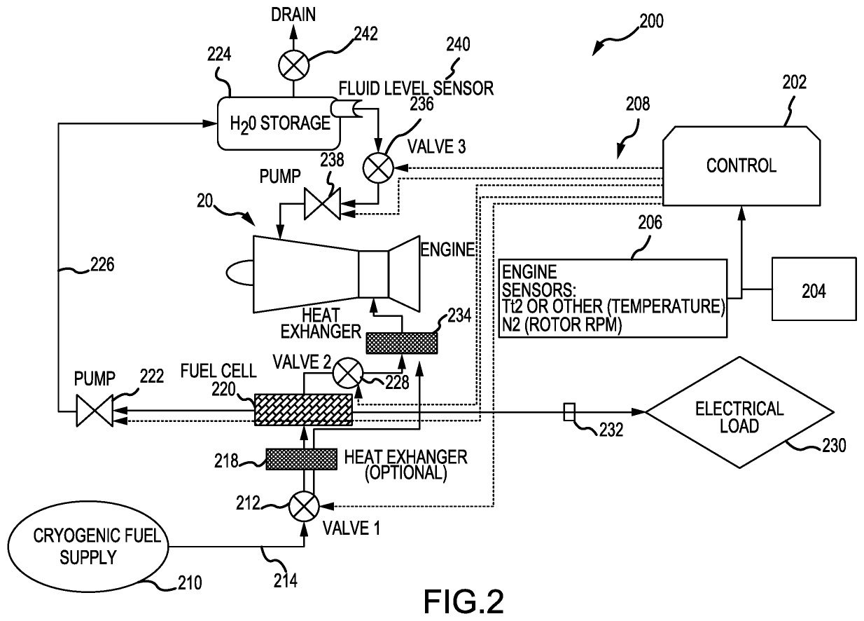

With additional reference to FIG. 2, system 200 is shown integrated with the gas turbine engine 20 of aircraft 10 according to various embodiments. System 200 includes a controller 202 which may be integrated into computer systems onboard aircraft 10. In various embodiments, controller 202 may be configured as a central network element or hub to access various systems, engines, and components of system 200. Controller 202 may comprise a network, computer-based system, and/or software components configured to provide an access point to various systems, engines, and components of system 200. In various embodiments, controller 202 may comprise a processor. In various embodiments, controller 202 may be implemented in a single processor. In various embodiments, controller 202 may be implemented as and may include one or more processors and/or one or more tangible, non-transitory memories and be capable of implementing logic. Each processor can be a general purpose processor, a digital signal processor (DSP), an application specific integrated circuit (ASIC), a field programmable gate array (FPGA) or other programmable logic device, discrete gate or transistor logic, discrete hardware components, or any combination thereof. Controller 202 may comprise a processor configured to implement various logical operations in response to execution of instructions, for example, instructions stored on a non-transitory, tangible, computer-readable medium configured to communicate with controller 202. In this regard, controller 202 may be configured to control various components of system 200 via control signals 208.

System program instructions and/or controller instructions may be loaded onto a non-transitory, tangible computer-readable medium having instructions stored thereon that, in response to execution by a controller, cause the controller to perform various operations. The term “non-transitory” is to be understood to remove only propagating transitory signals per se and includes all standard computer-readable media that are not only propagating transitory signals per se.

In various embodiments, controller 202 may be in electronic communication with a pilot through a control interface 204 of cockpit controls 16, for example, a multifunction display, a switch panel, and/or the like which an operator can operate. The control interface 204 may enable the operator to interact with system 200 for example, to issue commands, display information such as, for example, warnings, or receive outputs. Control interface 204 may comprise any suitable combination of hardware, software, and/or database components.

System 200 comprises one or more feedback elements to monitor and measure aircraft 10 and gas turbine engine 20 characteristics. For example, controller 202 is in electronic communication with sensors 206 that may be coupled to or in direct electronic communication with aircraft systems such as, for example, propulsion systems, fuel systems (e.g., primary and/or cryogenic fuel systems), and/or the like. Controller 202 may be in electronic communication with the full suite of aircraft sensors and other data sources available within and without the aircraft 10. Sensors 206 may comprise a temperature sensor, a torque sensor, a speed sensor, a pressure sensor, a position sensor, an accelerometer, a voltmeter, an ammeter, a wattmeter, an optical sensor, or any other suitable measuring device known to those skilled in the art. Sensors 206 may be configured to transmit measurements to controller 202, thereby providing sensor feedback about the measured system. The sensor feedback may be, for example, a speed signal, or may be position feedback, temperature feedback, pressure feedback or other data.

System 200 includes a cryogenic fuel supply 210 which may be configured to store a fuel such as a cryogenic liquid fuel. In various embodiments, the fuel may be one of molecular hydrogen, methane, ethane, propane, butane, natural gas and/or the like. The secondary fuel supply 210 is in fluid communication with a bypass-control valve 212 (e.g., a first valve) via supply line 214. The bypass-control valve 212 is in fluid communication with a fuel cell 220 and may be configured to control the fuel flow to a fuel cell 220. In various embodiments, bypass-control valve 212 is in fluid communication with a primary heat exchanger 234 (i.e., a first heat exchanger) and may be configured to distribute fuel flow to the primary heat exchanger 234. In this regard, bypass-control valve 212 may distribute the fuel flow relatively between the fuel cell 220 and the primary heat exchanger 234 or may be configured to bypass the fuel cell 220. The primary heat exchanger 234 may extract heat from the gas turbine engine 20 and impart heat energy to the cryogenic fuel. In this regard, the primary heat exchanger 234 is configured to vaporize and expand the cryogenic fuel and deliver heated gaseous fuel to a combustion chamber of the engine (e.g., combustor 56). In various embodiments, the bypass-control valve 212 may be in fluid communication with a secondary heat exchanger 218 (i.e., a second heat exchanger) configured to impart heat energy to the cryogenic fuel and provide heated fuel to the fuel cell 220.

In various embodiments, the fuel cell 220 may be electrically coupled to an electrical load 230 such as, for example, an electrical power system of aircraft 10. In response to receiving the fuel from the bypass-control valve 212, the fuel cell 220 may consume a portion of the fuel to generate electrical power and a byproduct such as, for example, liquid water. In various embodiments, the electrical load 230 may be disconnected from the fuel cell 220 by, for example, an electrical load disconnect relay 232. In various embodiments, the fuel cell 220 may be in fluid communication with an isolation valve 228 (e.g., a second valve) and may pass an unused portion of the fuel to the isolation valve. The fuel cell 220 is in fluid communication with a byproduct storage tank 224. In various embodiments, a transfer pump 222 (e.g., a first pump) is configured to byproduct from the fuel cell 220 to the water storage tank 224 via waste water lines 226.

Water storage tank 224 is in fluid communication with an injection valve 236 (e.g., a third valve) which is configured to regulate fluid communication between the byproduct storage tank 224 and the gas turbine engine 20. In various embodiments, the injection valve 236 may thereby provide the byproduct to a mass injection system of the gas turbine engine configured to deliver the byproduct to a compressor stage, an intercooler, an aftercooler, a combustor, a turbine stage, and/or the like and thereby tend to improve the performance of the gas turbine engine 20. For example, performance may be improved by an increase in mass flow along with an accompanying change in air temperature within the gas turbine due to a latent heat of evaporation of the injected byproduct (e.g., liquid water). The increased mass flow may tend to increase generated thrust by the gas turbine engine 20. In various embodiments, a mass injection system may generate multiple beneficial effects including reducing the temperature of air compressed in engine 20's fan 42 and/or low pressure compressor 44 and/or high pressure compressor 52. In this regard, by tending to enable reduction in air temperature during the most severe operating conditions, system 200 may thereby enhance the durability and reliability of gas turbine engine 20 components.

In various embodiments, an injector pump 238 (e.g., a second pump) may be in fluid communication relatively between the injector valve 236 and the gas turbine engine 20. The injector pump 238 may be configured to increase the pressure of the byproduct above an operating pressure of the gas turbine engine 20. In various embodiments, the byproduct storage tank 223 may include a fluid level sensor 240 in communication with the controller 202. The byproduct storage tank 224 may be in fluid communication with a drain valve 242 (e.g., a fourth valve) which may be controlled by controller 202 in response to a signal from the fluid level sensor 240. In this regard, the controller 202 may tend to inhibit overfilling of the byproduct storage tank 224.

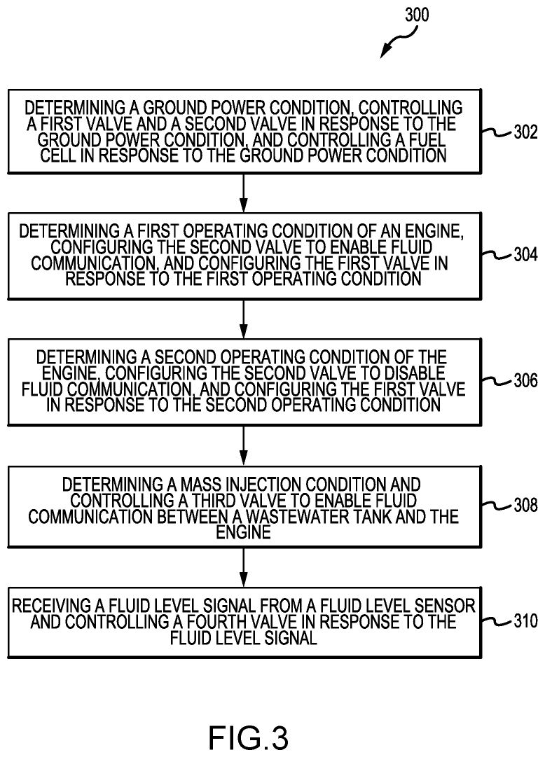

With additional reference to FIG. 3, a method 300 of controlling a cryogenic fuel auxiliary power system is illustrated according to various embodiments. Method 300 comprises determining a ground power condition, controlling the first valve and the second valve in response to the ground power condition, and controlling the fuel cell in response to the ground power condition (step 302). Method 300 includes determining a first operating condition of the engine, configuring the second valve to enable fluid communication between the fuel cell and the primary heat exchanger in response to the first operating condition, and configuring the first valve to supply a first portion of the fuel flow to the fuel cell and a second portion of the fuel flow to the primary heat exchanger in response to the first operating condition (step 304). Method 300 includes determining a second operating condition of the engine, configuring the second valve to inhibit fluid communication between the fuel cell and the primary heat exchanger in response to the second operating condition, and configuring the first valve to supply the fuel flow to the primary heat exchanger in response to the second operating condition (step 306). Method 300 includes determining a mass injection condition and controlling a third valve to enable fluid communication between the byproduct tank and the engine in response to the mass injection condition (step 308). In various embodiments, method 300 includes receiving a fluid level signal from a fluid level sensor in electronic communication with the controller and controlling a fourth valve in response to the fluid level signal (step 310).

Benefits and other advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, and any elements that may cause any benefit or advantage to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A cryogenic fuel auxiliary power system for an engine, comprising:
a cryogenic fuel supply;
a first valve in fluid communication with the cryogenic fuel supply and configured to control a fuel flow;
a first heat exchanger, configured to receive the fuel flow, in fluid communication with the first valve and a combustion chamber of the engine; and
a fuel cell in fluid communication between the first valve and the first heat exchanger.

2. The system of claim 1 further comprising a second valve in fluid communication with the fuel cell and the first heat exchanger and configured to interrupt the fluid communication therebetween.

3. The system of claim 2, further comprising a byproduct line in fluid communication with the fuel cell and a byproduct storage tank, wherein the fuel cell is configured to supply byproduct to the byproduct storage tank in response to receiving the fuel flow.

4. The system of claim 3, further comprising a transfer pump in fluid communication between the fuel cell and the byproduct storage tank.

5. The system of claim 4, further comprising a third valve in fluid communication between the byproduct storage tank and the engine, wherein the third valve is configured to supply the byproduct to a mass injection system of the engine.

6. The system of claim 5, further comprising a second pump in fluid communication between the third valve and the engine, wherein the second pump is configured to boost the pressure of the byproduct above an operating pressure of the engine.

7. The system of claim 6, further comprising a fourth valve in fluid communication between the byproduct storage tank and a drain.

8. The system of claim 7, further comprising a second heat exchanger in fluid communication between the first valve and the fuel cell.

9. The system of claim 7 further comprising:
a controller;
a sensor in communication with the controller and configured to provide sensor feedback; and
a tangible, non-transitory memory configured to communicate with the controller, the tangible, non-transitory memory having instructions stored thereon that, in response to execution by the controller, cause the controller to perform operations comprising:
determining, by the controller, a ground power condition;
controlling, by the controller, the first valve to enable fluid communication and the second valve to interrupt fluid communication in response to the ground power condition; and
controlling, by the controller, the fuel cell in response to the ground power condition.

10. The system of claim 9, wherein the operations further comprise:
determining, by the controller, a first operating condition of the engine;
configuring, by the controller, the second valve to enable fluid communication between the fuel cell and the first heat exchanger in response to the first operating condition; and
configuring, by the controller, the first valve to supply a first portion of the fuel flow to the fuel cell and a second portion of the fuel flow to the first heat exchanger in response to the first operating condition.

11. The system of claim 10, wherein the operations further comprise:
determining, by the controller, a second operating condition of the engine;
configuring, by the controller, the second valve to inhibit fluid communication between the fuel cell and the first heat exchanger in response to the second operating condition; and
configuring, by the controller, the first valve to supply the fuel flow to the first heat exchanger in response to the second operating condition.

12. The system of claim 11, wherein the operations further comprise:
determining, by the controller, a mass injection condition; and
controlling, by the controller, the third valve to enable fluid communication between the byproduct storage tank and the engine in response to the mass injection condition.

13. The system of claim 12, wherein the operations further comprise:
receiving, by the controller, a fluid level signal from a fluid level sensor in electronic communication with the controller; and
controlling, by the controller, the fourth valve in response to the fluid level signal.

14. A method for controlling a cryogenic fuel auxiliary power system for an engine, comprising:
determining, by a controller, a ground power condition;
controlling, by the controller, a first valve and a second valve in response to the ground power condition; and
controlling, by the controller, a fuel cell in response to the ground power condition.

15. The method of claim 14, further comprising:
determining, by the controller, a first operating condition of the engine;
configuring, by the controller, a second valve to enable fluid communication between a fuel cell and a first heat exchanger in response to the first operating condition; and
configuring, by the controller, the first valve to supply a first portion of a fuel flow to the fuel cell and a second portion of the fuel flow to the first heat exchanger in response to the first operating condition.

16. The method of claim 15, further comprising:
determining, by the controller, a second operating condition of the engine;
configuring, by the controller, the second valve to inhibit fluid communication between the fuel cell and the first heat exchanger in response to the second operating condition; and
configuring, by the controller, the first valve to supply the fuel flow to the first heat exchanger in response to the second operating condition.

17. An article of manufacture including a tangible, non-transitory computer-readable storage medium having instructions stored thereon that, in response to execution by a processor, cause the processor to perform operations comprising:
determining, by the processor, a ground power condition;
controlling, by the processor, a first valve and a second valve in response to the ground power condition; and
controlling, by the processor, a fuel cell in response to the ground power condition.

18. The article of manufacture of claim 17, wherein the operations further comprise:
determining, by the processor, a first operating condition of an engine;
configuring, by the processor, a second valve to enable fluid communication between the fuel cell and a first heat exchanger in response to the first operating condition; and
configuring, by the processor, the first valve to supply a first portion of a fuel flow to the fuel cell and a second portion of the fuel flow to the first heat exchanger in response to the first operating condition.

19. The article of manufacture of claim 18, wherein the operations further comprise:
determining, by the processor, a second operating condition of the engine;
configuring, by the processor, the second valve to inhibit fluid communication between the fuel cell and the first heat exchanger in response to the second operating condition; and
configuring, by the processor, the first valve to supply the fuel flow to the first heat exchanger in response to the second operating condition.

20. The article of manufacture of claim 19, wherein the operations further comprise:
determining, by the processor, a mass injection condition; and
controlling, by the processor, a third valve to enable fluid communication between a byproduct storage tank and the engine in response to the mass injection condition.
